(19) United States
(12) Patent Application Publication
(10) Pub. No.: US 2016/0027064 A1
(43) Pub. Date: Jan. 28, 2016

(54) BRAND MATCHING SYSTEMS FOR EMBEDDED MARKETING

(71) Applicant: Frank Zazza, New Rochelle, NY (US)

(72) Inventor: Frank Zazza, New Rochelle, NY (US)

(21) Appl. No.: 14/866,436

(22) Filed: Sep. 25, 2015

(51) Int. Cl. G06Q 30/02; G06F 17/30

(52) U.S. Cl. CPC G06Q 30/0269; G06F 17/3053; G06F 17/30864

(57) ABSTRACT

Systems for automatically matching brands and mass media items for product placement within the mass media items. The systems including a computer having at least a processor and a non-transitory computer-readable storage medium, the non-transitory computer-readable storage medium having computer-readable instructions for receiving brand parameters for a brand, receiving mass media parameters for a mass media item, and calculating a match suitability index by comparing the brand parameters with the mass media parameters. In some examples, the system includes a brand database. In some further examples, the system includes a mass media item database.

### BACKGROUND

The present disclosure relates generally to brand matching systems for embedded marketing. In particular, systems and methods for automatically matching brands and mass media items for embedded marketing are described.

Embedded marketing (i.e., product placement) is an advertising strategy that involves including or referring to brands and products within a media item (e.g., movie, TV show, web series, magazine article, book, website, live performance, etc.). Embedded marketing can generate a greater emotional tie to the brand or product over other forms of advertising and is an important tool in conveying characteristics of the brand to the public. In general, embedded marketing is most effective when characteristics of the brand or product are matched to those of a media item.

Known methods of matching brands and media items for embedded marketing are not entirely satisfactory for the range of applications in which they are employed. For example, existing methods often include creating focus groups from selected members of the public to carry out a qualitative research study. Research via focus groups, however, is inefficient in both cost and time. In addition, conventional methods have no standardized mechanism for retaining and sharing product and/or brand-media suitability information gathered from focus groups.

Another limitation of existing methods for matching brands with media content involves the lack of ways to quantitatively assess the suitability of a proposed match. Marketing and brand executives would benefit from a way rigorously and quantitatively compare different potential combinations of brands and media items. A quantitative measure of a brand and media content pairing would help establish appropriate values for associated marketing initiatives.

Thus, there exists a need for brand matching systems to more effectively match brands and mass media items in embedded marketing applications. Examples of new and useful brand matching systems and methods relevant to the needs existing in the field are discussed below.

Sophisticated marketing specialists recognize that brands and products are distinct from each other. However, many consumers refer to brands and products interchangeably. This disclosure will refer to both brands and products interchangeably as well except when the distinction between a product and a brand associated with a product is necessary for a more complete understanding.

### SUMMARY

The present disclosure is directed to systems for automatically matching brands and mass media items for product placement within the mass media items. Each of the systems include a computer having at least a processor and a non-transitory computer-readable storage medium, the non-transitory computer-readable storage medium having computer-readable instructions for: receiving brand parameters for a brand, receiving mass media parameters for a mass media item, and calculating a match suitability index by comparing the brand parameters to the mass media parameters. In some examples, the system includes a brand database. In some further examples, the system includes a mass media item database.

### BRIEF DESCRIPTION OF THE DRAWINGS

FIG. 1 shows a schematic view of an example of a programmable computing device for use with the brand matching system shown in FIG. 3.

FIG. 2 shows a schematic view of an example of a mobile electronic device for use with the brand matching system shown in FIG. 3.

FIG. 3 is a schematic view of a first example of brand matching system.

FIG. 4 is a flow diagram of a first example method of using the brand matching system shown in FIG. 3.

FIG. 5 is a flow diagram of a second example method of using the brand matching system shown in FIG. 3.

FIG. 6 is an example match suitability index calculation for a first media item and a first brand carried out by the brand matching system shown in FIG. 3.

FIG. 7 is an example match suitability index calculation for a second media item and the first brand carried out by the brand matching system shown in FIG. 3.

FIG. 8 is an example match suitability calculation for the first media item and a second brand carried out by the brand matching system shown in FIG. 3.

FIG. 9 is an example match suitability calculation for the second media item and the second brand carried out by the brand matching system shown in FIG. 3.

### DETAILED DESCRIPTION

The disclosed brand matching systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various brand matching systems and methods for embedded marketing are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

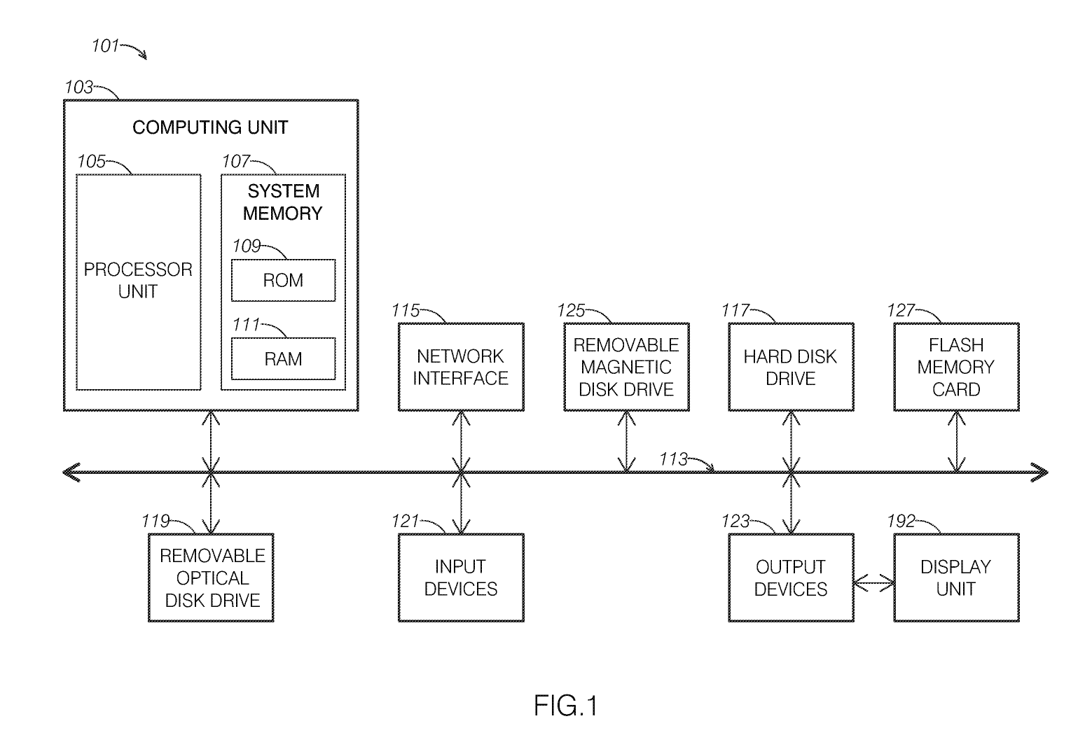

With reference to FIGS. 1-9, a first example of a brand matching system, brand matching system 300, will now be described. System 300 functions to receive and store parameter information (i.e., characteristics) for media items and brands. Further, system 300 functions to match media items and brands based on their respective parameter information by calculating a match suitability index. Additionally or alternatively, system 300 can function to calculate and send to the user a ranked list of highest matching media items and/or brands.

The reader will appreciate from the figures and description below that system 300 addresses shortcomings of conventional methods for matching brands and mass media items for embedded marketing. For example, system 300 is both time and cost effective compared to assessing embedded marketing via public focus groups. Further, system 300 can be used to retain and share brand and/or media item information. Moreover, system 300 provides a quantitative measure of how effective a proposed brand-media pairing would be to help direct marketing efforts and budgets.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

Accordingly, FIG. 1 shows one illustrative example of a computer, computer 101, which can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according to the various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Windows-based (including Windows Mobile and Windows 8), or Android operating systems.

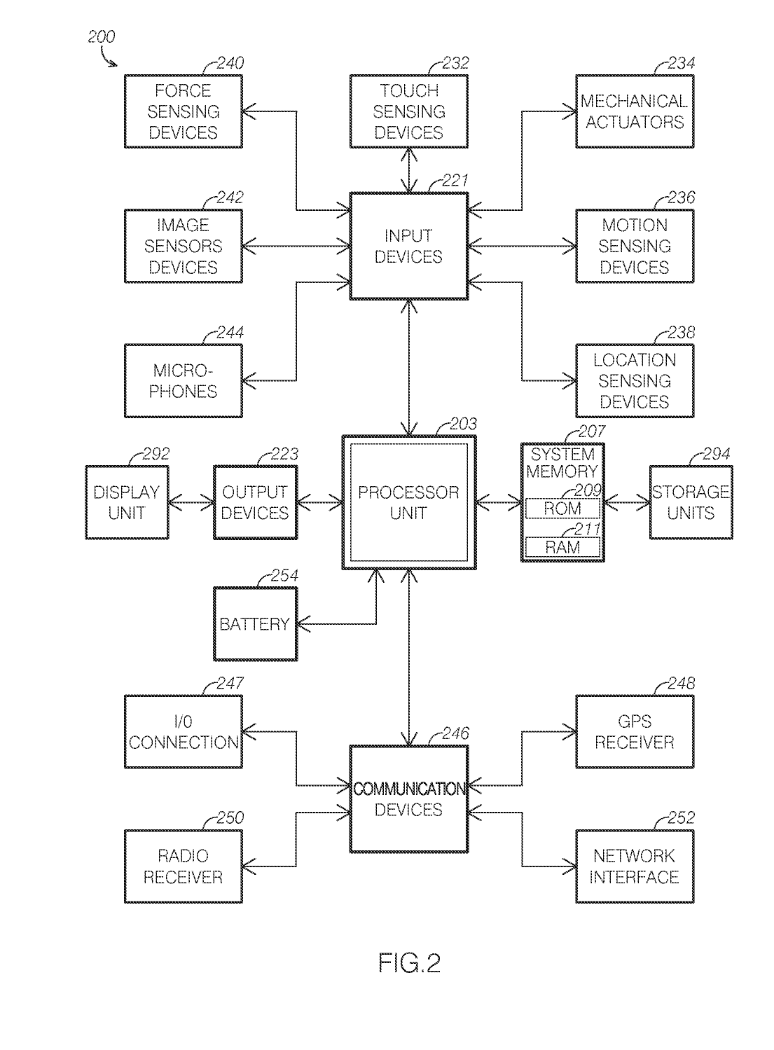

With reference to FIG. 2, an exemplary mobile device, mobile device 200, may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well known operating systems such as iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include the following: touch sensing devices 232 such as touch screens, touch pads and touch sensing surfaces; mechanical actuators 234 such as button or wheels or hold switches; motion sensing devices 236 such as accelerometers; location detecting devices 238 such as global positioning satellite receivers, WiFi based location detection functionality, or cellular radio based location detection functionality; force sensing devices 240 such as force sensitive displays and housings; image sensors 242; and microphones 244. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

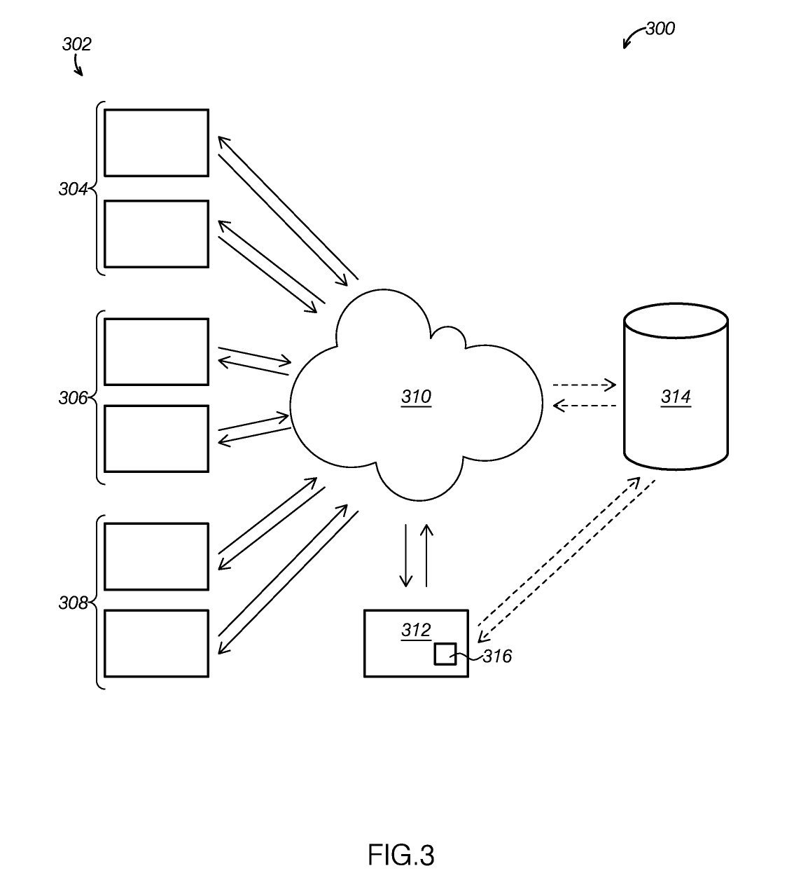

Turning now to FIG. 3, the reader can see that brand matching system 300 includes a plurality of user computers 302 (i.e., computers 304, 306, and 308), a network location 310, a system computer 312, and a database 314. In other examples, the brand matching system can include more or fewer user computers. Further, in other examples, the brand matching system includes additional system computers, network locations, and/or databases.

It will be appreciated that the plurality of user computers can include any of the computing devices described above in reference to computer 101 shown in FIG. 1 and mobile device 200 shown in FIG. 2. As depicted in FIG. 3, user computers 302 are comprised of media associated user computers 304, brand and media associated user computers 306, and brand associated user computers 308. In one example, user computers 304 are computers of users associated with media items (e.g., media creators, media marketers, media producers, etc.), user computers 306 are computers of users associated with both media items and brands (e.g., advertising agents, etc.), and user computers 308 are computers of users associated with brands (e.g., brand creators, brand marketers, brand executives, etc.).

User computers 302 are in data communication with network location 310 for accessing system computer 312 and/or database 314. In some examples, system computer 312 is directly in data communication with database 314, and in other examples, system computer 312 accesses database 314 via network location 310. It will be appreciated that, in even other examples, system computer 312 and database 314 can be one computing device. As depicted in FIG. 3, system computer 312 includes a system memory 316 (i.e., a non-transitory computer readable storage medium) for storing and executing computer readable instructions for using system 300.

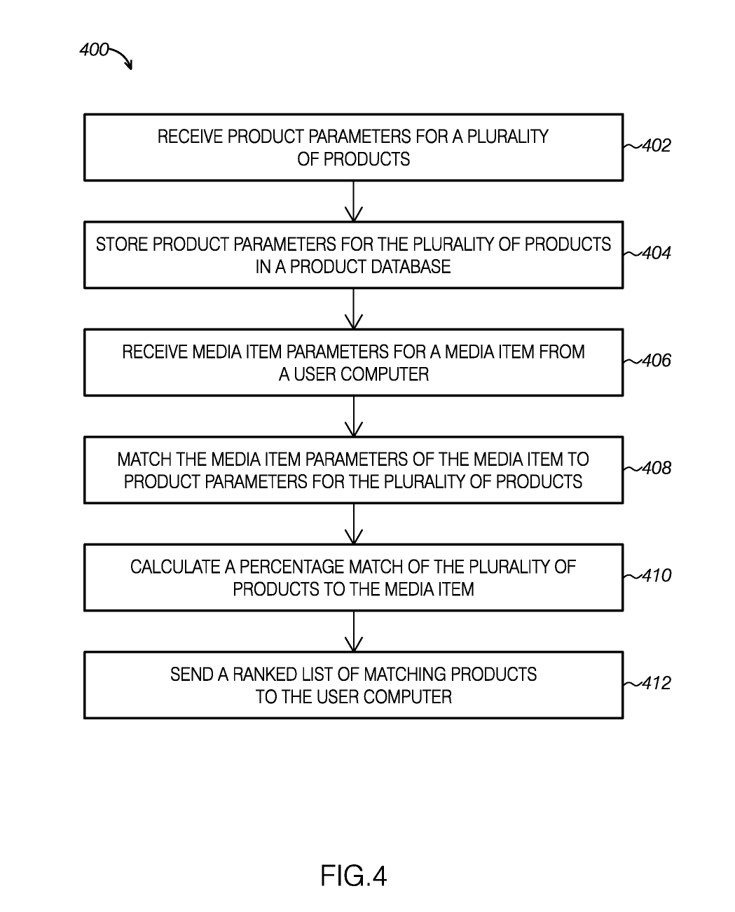

FIG. 4 shows a first example method 400 for using system 300. In the example of method 400, database 314 is configured to receive and store brand parameters for a plurality of brands or products. In some examples, database 314 is a brand database. Further, in the example of method 400, the network location is configured to receive a query (including media item parameters for a media item) from one of user computers 304 and 306. The network then sends the user query to system computer 312. It will be appreciated that system memory 316 includes non-transitory computer-readable instructions for carrying out method 400.

Specifically, method 400 includes receiving product parameters for a plurality of products at step 402, and storing the parameters for the plurality of products in a product database. In some examples, parameters for the plurality of products are received from product associated user computers, such as user computers 306 and 308. In other examples, the parameters for the plurality of products can be received from one or more external databases of product parameters, such as a database from a corporation or advertising agency representing and/or managing multiple products.

Next, at step 406, method 400 includes receiving media item parameters for a media item from a user computer, such as user computers 304 and 306. It will be appreciated that receiving media item parameters for a media item is a user query for determining product matches for the queried media item. As described above, the query is received at network location 310 and communicated to system computer 312. System computer 312 is configured to receive the query from network location 310 and perform a comparison (i.e., matching) of the media item parameters received in the query to the parameters of the plurality of products stored in database 314, as shown in step 408. Further, system computer 312 calculates a match suitability index for each of the plurality of products to the media item and sends a ranked list of the matching brands to the user computer via network location 310, at steps 410 and 412, respectively.

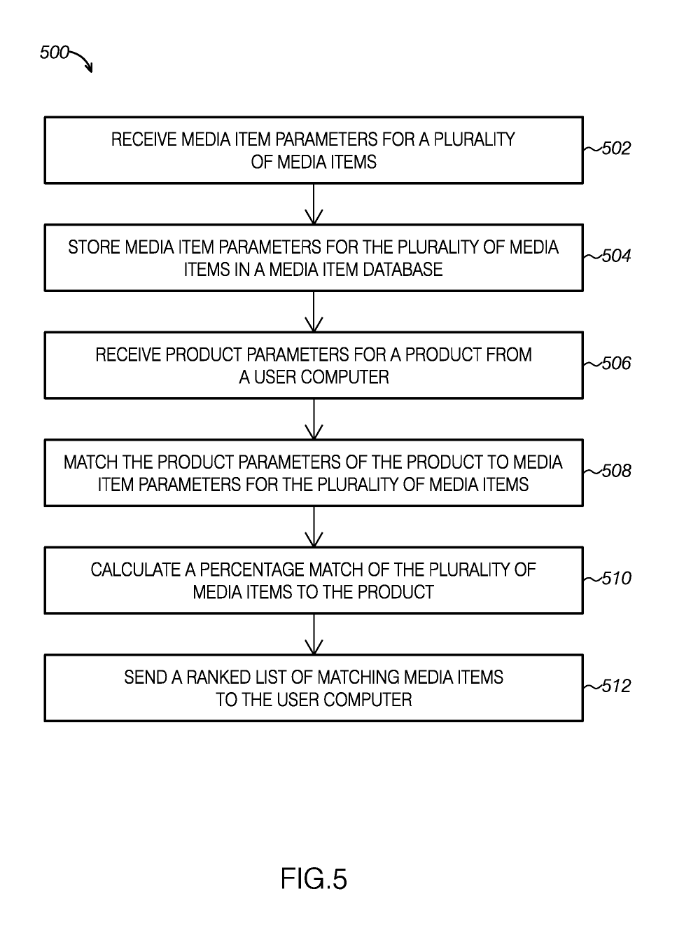

Alternatively or additionally, a second method, method 500, may be employed by system 300 as shown in FIG. 5. In method 500, database 314 is configured to receive and store media item parameters for a plurality of media items. In some examples, database 314 is a media item database. Further in method 500, the network location is configured to receive a query (including product parameters for a product) from one of user computers 306 and 308. The network then sends the user query to system computer 312. It will be appreciated that system memory 316 includes non-transitory computer-readable instructions for carrying out method 500.

Specifically, method 500 includes receiving media item parameters for a plurality of media items at step 502, and storing the parameters for the plurality of brands in a brand database. In some examples, parameters for the plurality of brands are received from media item associated user computers, such as user computers 304 and 306. In other examples, the parameters for the plurality of media items can be received from one or more external databases of media item parameters, such as a database from a corporation or media agency representing and/or managing multiple media items.

Next, at step 506, method 500 includes receiving brand parameters for a brand from a user computer, such as user computers 306 and 308. It will be appreciated that receiving brand parameters for a brand is a user query for determining media item matches for the queried brand. As described above, the query is received at network location 310 and communicated to system computer 312. System computer 312 is configured to receive the query from network location 310 and perform a comparison (i.e., matching) of the brand parameters received in the query to the parameters of the plurality of media items stored in database 314, as shown in step 508. Further, system computer 312 calculates a match index for each of the plurality of media items to the brand and sends a ranked list of the matching media items to the user computer via network location 310, at steps 510 and 512, respectively.

For both of methods 400 and 500, it will be appreciated that the media item parameters and brand parameters can include a variety of characteristics or traits for the various media items and brands or products. In some examples, system 300 can include a graphical user interface (GUI) on each of the user computers, where each parameter includes a selectable and/or ratable list of traits. In other examples, the GUI can be configured to receive data entries from a user. Further, it will be appreciated that methods 400 and 500 can both be carried out using system 300 simultaneously or alternatingly. Accordingly, database 413 can be both a brand database and a media item database and store parameters for both brands and media items.

A wide range of brand parameters may be considered by the brand matching system. The brand parameters may include one or more of the following brand parameters: brand psychographics, brand demographics, brand activation, brand passion, brand attitude, brand behavior, brand voice, brand physical appearance, brand personality, brand interest, brand values, brand essence, brand identity, and brand promise.

Media item parameters can include one or more of the following parameters: character psychographics, character demographics, character activity, character opinion, character attitude, character behavior, character voice, character physical appearance, character personality, character interest, character values, character essence, character identity, and character bucket list.

Calculating a match suitability index involves comparing the plurality of brand parameters to the plurality of mass media parameters and calculating a percentage match for one or more of the parameters. For example, percentage matches for the following parameters may calculated: brand psychographics and character psychographics, brand demographics and character demographics, brand activity and character activity, brand passion and character opinion, brand attitude and character attitude, brand behavior and character behavior, brand voiced and character voice, brand physical appearance and character physical appearance, brand personality and character personality, brand interest and character interest, brand values and character values, brand essence and character essence, brand identity and character identity, and brand promise and character bucket list. Alternatively or additionally, the brand parameters and the media item parameters can include other parameters and/or have a different pairing of brand parameters and media item parameters.

The brand and media item parameters listed above will now be described in more detail.

The brand psychographics parameter is based on analysis of consumer lifestyles to create a detailed customer profile. This can be information collected by market researchers by asking consumers to agree or disagree with activities, interests, and opinion statements. Results can be combined with geographic (e.g., place of work, place of residence, etc.) and/or demographic (e.g., age, education, occupation, etc.) characteristics to create a targeted consumer segment.

The brand demographics parameter considers selected population characteristics as used in government, marketing or opinion research, and/or demographic profiles used in such research. Commonly-used demographics include race, age, income, disabilities, mobility (e.g. travel time to work, number of vehicles available, etc.), educational level, home ownership, employment status, and location. Distributions of values within a demographic variable or across households, as well as trends over time, can also be included.

The brand passion parameter focuses on traits that are of interest to consumers. Consumers are known to respond to brand traits that are adventurous and/or rebellious, desirable and/or sexy, playful and/or fun, and creative. Each of these traits represents positive descriptors for relationships or views a consumer can hold for a brand or product.

The brand activation parameter considers descriptors for the emotional level of a consumer engaging with the brand or product (e.g., trust in the product), thereby driving them to take action. The most common example of brand activation is emotional buying. Emotional buying occurs when a consumer purchases a product in response to emotions triggered by seeing the product or brand. The consumer's emotions are often based on his or her knowledge of the brand or product obtained through advertising for the product.

The degree of brand activation may depend on information provided by a brand manager. Brand activation information may include how much awareness the brand has instilled in consumers; the degree to which media purchases are in sync with the brand marketing launch; and whether there are rebates or gifts included with purchases. Other brand activation information may include the type of display used to display the product in a store; whether the brand is positioned on a shelf or featured on a display at an end of an aisle; and whether the brand's timing is aligned with consumers' needs, e.g., back to school brands in late summer or snow plows in early winter.

The brand voice parameter reflects the tone in which a brand or product connects with consumers. Brand voice characteristics considered in this parameter may include whether the brand has authoritative, informative, fun, witty, or authentic traits. In some examples, the brand matching system includes prompts to assist the user in determining the brand voice parameter.

For example, the user can be prompted to answer one or more of the following questions regarding his or her target customer: “What does he or she look like?”; “What does he or she care about?”; “Where does he or she work?”; “What does he or she do for fun?”; and “What does he or she want from your brand/product?”.

Additionally or alternatively, the user can be prompted with one or more of the following fill-in questions: “I want my brand/product to make people feel ______.”; “______ makes me feel this way.”; “I want people to ______ when they come into contact with my brand/product”; “Three words that describe my brand/product are ______, ______, and ______.”; “I want to mimic the brand voice of ______”; “I dislike brand voices that sound ______.”; and “Interacting with my clients and potential clients makes me feel ______.”.

The brand promise parameter focuses on impressions and/or perceptions that occur from an encounter with a brand and/or product that become a consumer expectation of a product. Expectation can further include explicit expectation (i.e., function of the product), implicit expectation (i.e., inferred expectation as compared to other products), static performance expectation (i.e., performance of product in a specific situation), dynamic performance expectation (i.e., changes in expectation over time), technological expectation (i.e., enabling features of the product), interpersonal expectation (i.e., relationship of consumer with the product), and situational expectation (i.e., expected result after use of the product in a specific situation).

The brand attitude parameter reflects an opinion of consumers toward a brand determined through market research. The brand attitude parameter defines what consumers think about a product or service, whether the product answers a consumer need, and how much consumers want the brand.

There are two distinct examples of brand attitude. One example of brand attitude is fulfilling a need in a consumer's mind. Another example of brand attitude is creating a need in the consumer's mind. Most products consumers buy fulfill a need that they already have, e.g., gasoline for cars, lawnmowers to help cut people's grass, and coffee makers to brew coffee.

On the other hand, consumers can react to a brand's attitude because the brand has created a need that was not there prior to the consumer noticing the brand's advertising. Examples of a brand creating a need in consumers' minds include special additives to gasoline provide better gas mileage; a remote controlled, self-propelled lawnmower; or a gold plated coffee maker. A brand's attitude is especially important when trying to create needs in the minds of consumers.

The brand behavior parameter considers behavior that demonstrates that an organization is committed to delivering the desired brand and/or product. Brand behavior is fostered through the stewardship of a brand from inception to sale. Factors contributing to brand behavior include how the brand resonates with consumers over time and whether a brand has momentum and traction to take it to higher levels of consumer response.

Measuring milestone associated with brand behavior over time is helpful to assess whether a brand is meeting expectations set by brand managers. Suitable milestones include timeframes over which a brand meets certain criteria, consumers' recall and recognition of the brand, and sales of the product associated with the brand.

A brand behavior pattern may be determined based on the brand's performance in meeting the milestones set by brand managers. The degree of variation for a given brand behavior pattern may be quantified as a deviation percentage of the brand behavior pattern. The deviation percentage has been observed to be a key indicator in assessing effective matches between brands and mass media for embedded marketing.

The brand personality parameter is concerned with human characteristics attributed to a brand and/or product. Brand personality examples include: excitement (e.g., carefree, spirited, youthful, etc.), sincerity (e.g., genuine, kind, family-oriented, thoughtful, etc.), ruggedness (e.g., rough, tough, outdoors, athletic, etc.), competence (e.g., successful, accomplished, influential, leadership, etc.), and sophistication (e.g., elegant, prestigious, pretentious, etc.).

The brand identity parameter reflects the mode in which the business wants the customer to perceive the brand and/or product, such as brand name or product name, communication style, logo, and other visual elements, etc. A common example of how brand identity is established can be seen in magazines. Young successful models are connected with particular brands of clothes, watches, cars, places and food to identify those brands with such models.

Brand identity is different than brand image. Brand image is what consumers actually think whereas brand identity is constructed by the business itself. A negative gap between brand identity and brand image often means a company is out of touch with market sentiment for its brand. The brand image held by consumers can reach a point at which a business or product has to rebrand itself in order to fulfill the brand identity. Further, the gap between quantitative measures of brand identity and brand image is a relevant factor in the effectiveness of embedding marketing into a given mass media item for a given brand.

Quantifying brand identity may be accomplished by assigning factor values or percentages to certain metrics. For example, quantitative values may be assigned based on the existence or lack thereof of a unique trademark for the brand; whether the trademark is in the form of a name, logo, symbol, and/or slogan; and whether the brand is associated with a recognized character, such as Tony the Tiger, the Pillsbury Dough Boy, or the Geico Gecko.

Consumer surveys and other market research tools may be used to quantify the degree of brand image for a given brand. Numerical values or percentages can be assigned to answers for a series of questions in a survey or other market research tool. Tabulating the numerical values yields a quantitative measure for the brand image parameter for a given brand in the minds of consumers.

The brand value parameter refers to the premium that accrues to a brand from customers who are willing to pay more for a product because of the brand associated with the product above and beyond the value of the underlying product itself. A consumer's perception of value based on the brand supersedes the objective value of the underlying product. Brand value can be seen when consumers order Coke or Pepsi instead of “cola.” Companies invest substantial sums to create brand value for their brands.

A brand's value is a parameter used by the brand matching systems described herein to improve how effectively brands are matched with characters and other aspects of mass media. Quantifying a brand's value may be accomplished by assessing what a consumer is willing to pay for a product from a specific brand vs. an equivalent product from a generic brand. Surveys, focus group results, shopper marketing, and other market research tool may all provide quantitative assessments of a brand's value. Each tool provides a measure of the premium that consumers are willing to pay for a given brand, which can be quantified as a brand value and incorporated into the systems described herein.

The brand interest parameter encompasses the level of interest or intrigue the consumer has in the brand and the level of curiosity the customer has to inquire or learn more about the brand. A historical example of a brand exhibiting high brand interest would be Apple's Super Bowl commercial where a man flung a hammer that exploded on impact. Market research at the time revealed that the commercial generated a lot of interest and curiosity among consumers.

Recall and research studies may be used to quantify brand interest. Previews of coming attractions are an effective tool for forecasting brand interest and predicting a consumers engagement with a brand or likelihood of purchasing a product associated with a brand. Assigning a value to the brand interest factor weighted appropriately with regard to the other relevant factors allows the systems and methods described herein to use the brand interest parameter as a component in the overall assessment of which brands match well with which media content.

The brand essence parameter considers the degree to which consumers recall a brand upon being presented with a supplemental brand identifier. A supplemental brand identifier is a phrase, image, name, or jingle associated with the brand that does not include the brand name itself. Contemporary examples of supplemental brand identifiers with high measures of brand essence are the phrases “Like a good neighbor,” “You're in good hands,” or Just do it!” associated with the brands State Farm, Allstate, and Nike, respectively.

The brand essence parameter is qualitatively affected by a variety of characteristics and the effect of those characteristics may be quantified using predetermined criteria. For example, the applicant has observed that the following characteristics of the supplemental brand identifier affect the brand essence parameter: whether the supplemental identifier is:

Single-minded in that it includes only one or two words;

Unique in the sense that it differentiates from competitors;

Experiential, i.e., captures the feel of the customer during an encounter with the brand and/or product;

Consistently delivered in that it is delivered with every experience of the brand and/or product; and

Authentic in the sense that it adds credibility to the brand and/or product.

The brand matching systems and methods described herein include prompting a user to enter a quantitative measure of a brand's essence, i.e., the brand essence parameter, based on the criteria listed above. Of course, other characteristics or combinations of characteristics may be considered in addition or alternatively to the criteria discussed above. The brand matching systems and methods use the brand essence parameter, weighted appropriately with regard to the other relevant parameters, in the overall assessment of whether a given brand is an effective match with given media content.

The brand voice parameter considers the extent to which a speaker's distinctive pattern of modulation is associated with a brand in the mind of consumers without the speaker mentioning the brand name itself. Characteristics affecting the brand voice factor include a distinctive tone, speech pattern, volume, accent, or other audible quality of the character in the media item that sets the character apart from other characters in the media item and/or characters in other media items. Brand voice should not be confused with the character that a brand uses.

The brand voice parameter can be quantified by any currently known or later developed means. For example, surveys, focus groups, or computer algorithms may yield a distinctiveness factor for a given character's voice on a scale of 1 to 10 or 1 to 100 considering a variety of characteristics. Additionally or alternatively, the brand voice parameter may consider how well the speaker's voice distinguishes from graphics, slogans, colors used by other brands. The brand voice parameter is weighted relative to the other factors and used by the brand matching system to determine when a given brand is a good match for a given media item.

The character psychographics parameter describes details of a character in mass media content. Aspects of the character's personality, values, opinions, attitudes, interests, and lifestyle are reflected in the character psychographics parameter. For example, the character's opinion on gay marriage, abortion, and evolution may all be relevant to brand suitability and those characteristics may be captured in the character psychographic factor. Quantitative values are assigned to these and other characteristics to yield a numeric character psychographic parameter when the characteristics are entered into the brand matching system and tabulated.

The character demographics parameter considers aspects of the character's life separate from those considered in the character psychographics parameter. For example, the character demographics parameter may consider characteristics such as the characters age, sex, education level, income level, marital status, occupation, religion, and size of the character's family. Quantitative values may be assigned to these and other demographic characteristics to yield a numeric character demographics parameter used by the brand matching system.

The character personality parameter reflects aspects of a character's behavior and attitudes. In some examples, the user can be prompted with a list of adjectives (e.g., positive traits, negative traits, etc.) that the user can select and/or rate. Specifically, the user can rate each adjective as applicable to the character on a scale (e.g., a scale between one and five, one being not applicable and five being highly applicable). Further, in some examples, the user can enter comments as to the applicability of the adjective.

Examples of selectable and/or ratable positive traits can include: Religious, Honest, Loyal, Devoted, Loving, Kind, Sincere, Devoted, Ambitious, Satisfied, Happy, Faithful, Patient, Determined, Persistent, Adventurous, Homebody, Considerate, Cooperative, Cheerful, Optimistic, Pessimistic, Funny, Strong, Courageous, Reliable, Fearless, Daring, Tough, Brave, Charming, Loving, Affectionate, Lovestruck, and Charismatic.

Examples of selectable and/or ratable negative traits can include: Unkind, Dishonest, Disloyal, Mean, Rude, Disrespectful, Impatient, Greedy, Angry, Pessimistic, Repugnant, Cruel, Unmerciful, Wicked, Obnoxious, Malicious, Grumpy, Quarrelsome, Caustic, Selfish Domineering, Boorish, Persuasive, Ambitious, Bossy, Disparaging, Picky, Sly, Cold-hearted, Rude, Self-centered, Conceited, Unforgiving, Dauntless, Ugly, Evil, Cunning, Deceptive, Murderous, Psychotic, Domineering, Boorish, Persuasive, Ambitious, Bossy, Disparaging, Picky, Sly, Cold-hearted, Rude, Self-centered, and Conceited. Other examples of selectable and/or ratable traits can include: Educated, Informed, Playful, Zany, Active, Wild, Silly, Affectionate, Funny, Rough, Talkative, Rowdy, Smart, Fidgety, Shy, Lively, Submissive, and Stubborn.

The character physical appearance parameter relates to the physical appearance of a character, including the character's height, weight, hygiene, and other physical attributes, such as musculature, curviness, teeth whiteness or straightness, facial symmetry, skin color, hair color, and eye color. Other suitable physical appearance characteristics include how the character dresses; the accessories worn by the character; and the car driven by the character. Quantitative values may be assigned to these physical appearance characteristics and others to yield a numeric physical appearance parameter.

A given actor may have different physical appearances when portraying different characters and those different appearances may affect the suitability for a given brand. For example, Sylvester Stallone may embody the characters Rocky and Rambo, which have unique physical appearances: Rocky appearing as a courageous boxer and Rambo appearing as a desperate solder. The physical appearance of Rocky may be highly suitable for a deodorant brand whereas the physical appearance of Rambo may not be suitable for a deodorant brand.

The character activity parameter considers the activities carried out by a character within a media item. The character activity parameter may include characteristics such as quirks or obsessions of a character. Quantifying these and other character activity characteristics yields a character activity parameter that may be used by the brand matching system to determine effective brand-media pairings for embedded marketing.

The character bucket list parameter considers actions, experiences, goals, wishes, and desires the character in the media item intends to accomplish prior to his or her death or prior to the end of the story. One example of a goal would be a character's desire to find a cure for a disease that took the life of a friend. Quantified values can be assigned to different bucket list characteristics to provide a numeric bucket list parameter used by the brand matching system.

As discussed above, the product parameters or factors may include one or more of brand psychographics, brand demographics, brand activation, brand passion, brand attitude, brand behavior, brand voice, brand personality, brand interest, brand value, brand essence, brand identity, and brand promise. Further, media item parameters can include one or more of character psychographics, character demographics, character activity, character opinion, character voice, character physical appearance, character personality, and character bucket list.

As described above, calculating a match suitability index includes calculating a percentage match for one or more paired media item and brand parameters (e.g., brand psychographics and character psychographics, brand demographics and character demographics, brand activity and character activity, brand passion and character opinion, brand attitude and character attitude, brand behavior and character behavior, brand voiced and character voice, brand physical appearance and character physical appearance, brand personality and character personality, brand interest and character interest, brand values and character values, brand essence and character essence, brand identity and character identity, brand promise and character bucket list, etc). In some examples, scores for each of the paired media item and brand parameters are then averaged to calculate a percentage match of a media item and a product.

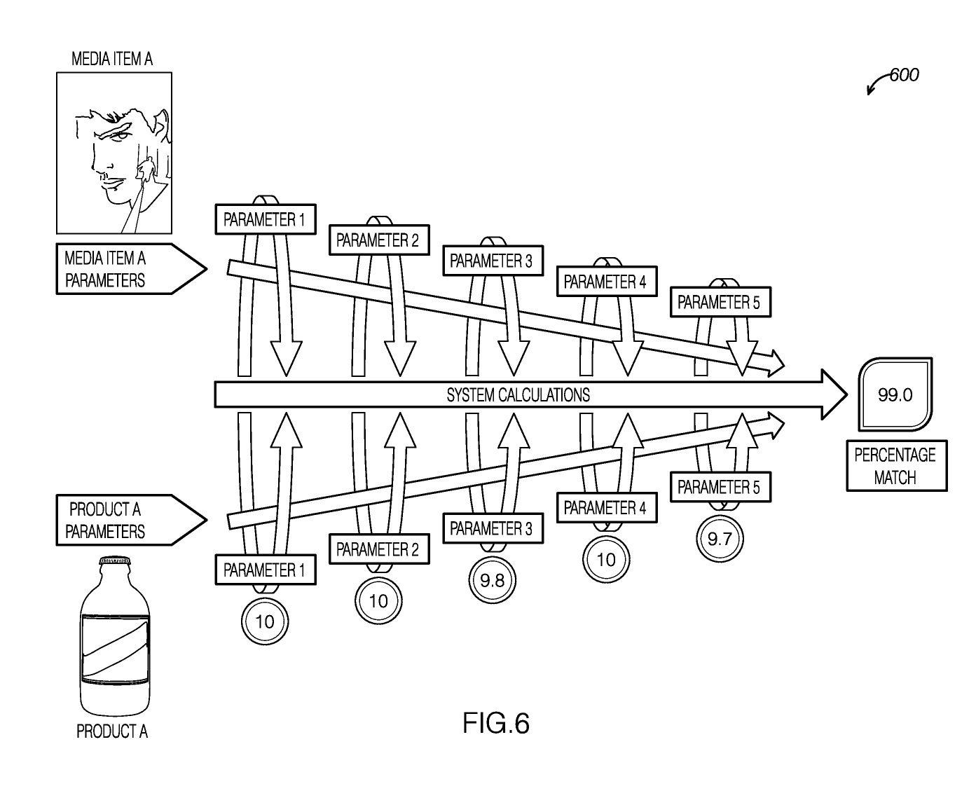

FIGS. 6-9 show specific example calculations for Media Items A and B and Products A and B. As can be seen in FIG. 6, in an example calculation 600, Media Item A (e.g., a drama movie) is compared with and/or matched with Product A (e.g., a beverage). In this example, parameters 1-5 are paired and a percentage of matching is calculated (i.e., parameters 1 are 100% matching, parameters 2 are 100% matching, parameters 3 are 98% matching, parameters 4 are 100% matching, and parameters 5 are 97% matching). Thus, a match suitability index (i.e., an average matching score) for Media Item A and Product A is 99.0%.

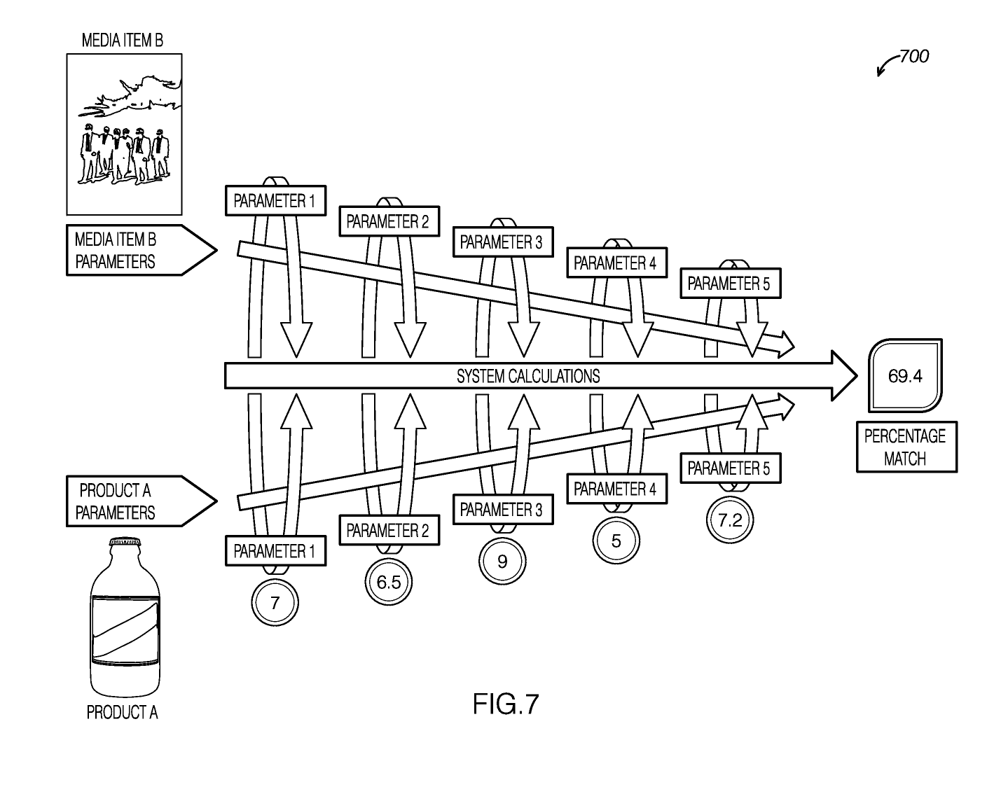

As can be seen in FIG. 7, in an example calculation 700, Media Item B (e.g., an action movie) is compared with and/or matched with Product A (e.g., a beverage). In this example, parameters 1-5 are paired and a percentage of matching is calculated (i.e., parameters 1 are 70% matching, parameters 2 are 65% matching, parameters 3 are 90% matching, parameters 4 are 50% matching, and parameters 5 are 72% matching). Thus, a match suitability index (i.e., an average matching score) for Media Item B and Product A is 69.4%.

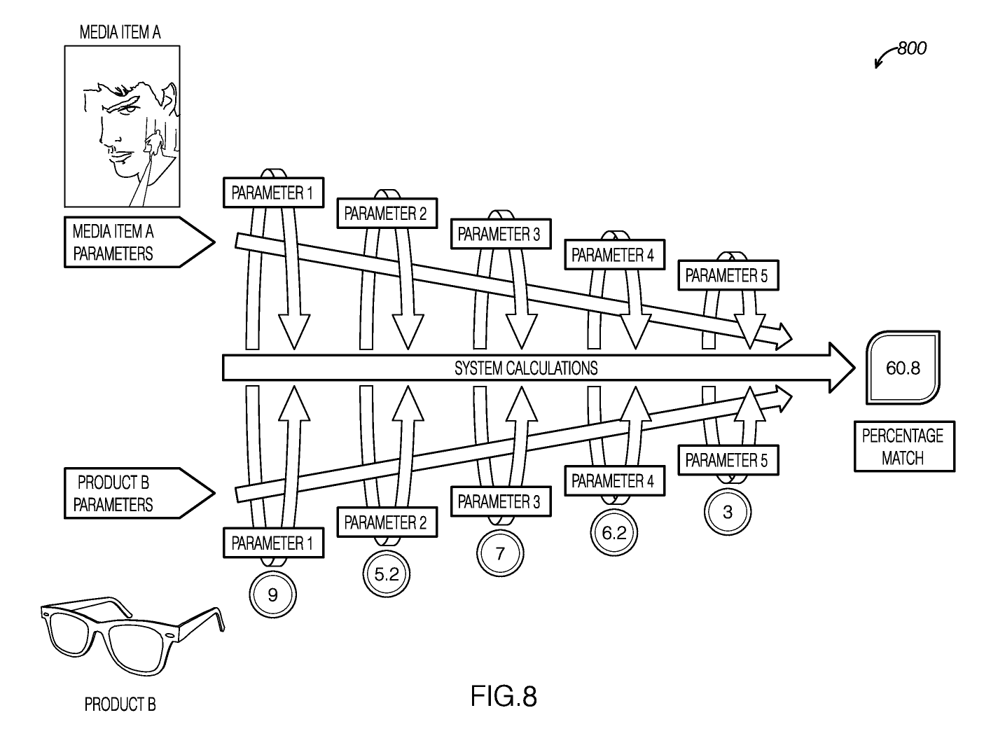

As can be seen in FIG. 8, in an example calculation 800, Media Item A (e.g., a drama movie) is compared with and/or matched with Product B (e.g., sunglasses). In this example, parameters 1-5 are paired and a percentage of matching is calculated (i.e., parameters 1 are 90% matching, parameters 2 are 52% matching, parameters 3 are 70% matching, parameters 4 are 62% matching, and parameters 5 are 30% matching). Thus, a match suitability index (i.e., an average matching score) for Media Item A and Product B is 60.8%.

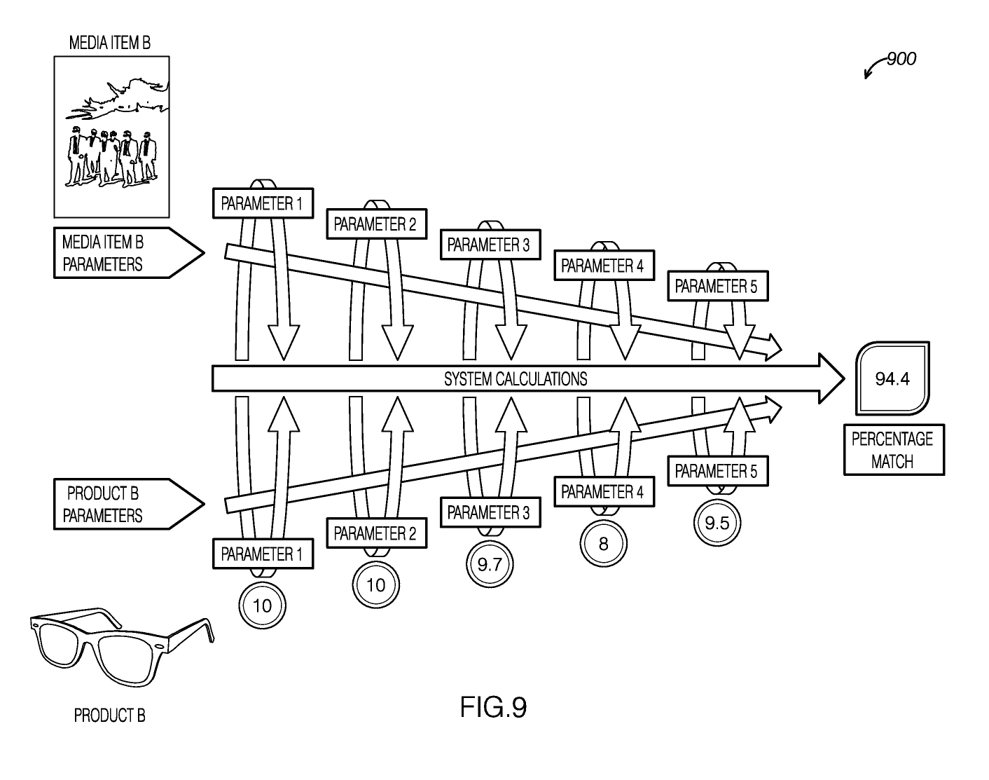

As can be seen in FIG. 9, in an example calculation 900, Media Item B (e.g., an action movie) is compared with and/or matched with Product B (e.g., sunglasses). In this example, parameters 1-5 are paired and a percentage of matching is calculated (i.e., parameters 1 are 100% matching, parameters 2 are 100% matching, parameters 3 are 97% matching, parameters 4 are 80% matching, and parameters 5 are 95% matching). Thus, a match suitability index (i.e., an average matching score) for Media Item B and Product B is 94.4%.

Accordingly, if a user entered a query to search for a matching media item for Product A, system 300 would return to the users computer a ranked list, where Media Item A was given a higher ranking than Media Item B. Further, if a user entered a query to search for a matching media item for Product B, system 300 would return to the user's computer a ranked list, where Media Item B was given a higher ranking than Media Item A. Alternatively, if a user entered a query to search for a matching product for Media Item A, system 300 would return to the user's computer a ranked list, where Product A was given a higher ranking than Product B. Furthermore, if a user entered a query to search for a matching product for Media Item B, system 300 would return to the user's computer a ranked list, where Product B was given a higher ranking than Product A.

It will be appreciated that the examples shown in FIGS. 6-9 are merely exemplary and the match suitability index calculations can include more or fewer parameters, more or fewer media items, and/or more or fewer products. Further, in other examples, one or more parameters can be give a greater weight than other parameters, as indicated or selected by the user entering the query. In these examples, more heavily weighted parameters can account for a greater portion of the match suitability index.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A system for automatically matching brands and mass media items for embedded marketing within the mass media items, comprising:
a computer having at least a processor and a non-transitory computer-readable storage medium, the non-transitory computer-readable storage medium having computer-readable instructions for:
receiving a plurality of brand parameters for at least one brand,
receiving a plurality of mass media parameters for at least one mass media item, and
calculating a match suitability index by quantitatively comparing the plurality of brand parameters with the plurality of mass media parameters.

2. The system of claim 1, further comprising a brand database, wherein the at least one brand includes a plurality of brands and the non-transitory computer-readable storage medium has further computer-readable instructions for:
storing the plurality of brand parameters for each of the plurality of brands in the brand database.

3. The system of claim 2, wherein the non-transitory computer-readable storage medium has further computer-readable instructions for:
comparing the plurality of mass media parameters for the at least one mass media item to the plurality of brand parameters for each of the plurality of brands in the brand database.

4. The system of claim 3, wherein the non-transitory computer-readable storage medium has further computer-readable instructions for:
returning a ranked list of brands that match the plurality of mass media parameters for the at least one mass media item.

5. The system of claim 1, further comprising a mass media item database, wherein the at least one mass media item is a plurality of mass media items and the non-transitory computer-readable storage medium has further computer-readable instructions for:
storing the plurality of mass media parameters for each of the plurality of mass media items in the mass media item database.

6. The system of claim 5, wherein the non-transitory computer-readable storage medium has further computer-readable instructions for:
comparing the plurality of brand parameters for the at least one brand to the plurality of mass media parameters for each of the plurality of mass media items in the mass media item database.

7. The system of claim 6, wherein the non-transitory computer-readable storage medium has further computer-readable instructions for:
returning a ranked list of mass media items that match the plurality of brand parameters for the at least one brand.

8. The system of claim 1, wherein the plurality of product parameters for the at least one product comprise one or more of brand psychographics, brand demographics, brand activity, brand opinion, brand attitude, brand behavior, brand voice, brand physical appearance, brand personality, brand interest, brand values, brand essence, brand identity, and brand promise.

9. The system of claim 1, wherein the plurality of mass media parameters for the at least one mass media item comprise one or more of character psychographics, character demographics, character activity, character opinion, character attitude, character behavior, character voice, character physical appearance, character personality, character interest, character values, character essence, character identity, and character promise.

10. The system of claim 1, wherein calculating a match suitability index comprises calculating a match for one or more of brand psychographics and character psychographics, brand demographics and character demographics, brand activity and character activity, brand opinion and character opinion, brand attitude and character attitude, brand behavior and character behavior, brand voiced and character voice, brand physical appearance and character physical appearance, brand personality and character personality, brand interest and character interest, brand values and character values, brand essence and character essence, brand identity and character identity, and brand promise and character promise.

11. The system of claim 1, wherein the at least one mass media item is at least one of a book, a movie, a TV series, a web series, a magazine article, a published short story, and a website.

12. The system of claim 1, wherein the score for matching of the plurality of brand parameters to the plurality of mass media parameters is a percentage of matching parameters.

13. A system for automatically matching products and mass media items for brand placement within the mass media items, comprising:
a brand database; and
a computer having at least a processor and a non-transitory computer-readable storage medium, the non-transitory computer-readable storage medium having computer-readable instructions for:
receiving a plurality of brand parameters for each of a plurality of brand,
receiving a plurality of mass media parameters for at least one mass media item, and
calculating a match suitability index by comparing the plurality of brand parameters with the plurality of mass media parameters.

14. The system of claim 13, wherein the non-transitory computer-readable storage medium has further computer-readable instructions for:
storing the plurality of mass media parameters for each of the plurality of mass media items in the mass media item database.

15. The system of claim 14, wherein the non-transitory computer-readable storage medium has further computer-readable instructions for:
comparing the plurality of mass media parameters for the at least one mass media item to the plurality of brand parameters for each of the plurality of brands in the brand database.

16. The system of claim 15, wherein the non-transitory computer-readable storage medium has further computer-readable instructions for:
returning a ranked list of brands that match the plurality of mass media parameters for the at least one mass media item.

17. A system for automatically matching products and mass media items for product placement within the mass media items, comprising:
a mass media item database,
a computer having at least a processor and a non-transitory computer-readable storage medium, the non-transitory computer-readable storage medium having computer-readable instructions for:
receiving a plurality of brand parameters for at least one brand,
receiving a plurality of mass media parameters for each of a plurality of mass media items, and
calculating a match suitability index by comparing the plurality of brand parameters to the plurality of mass media parameters.

18. The system of claim 17, wherein the non-transitory computer-readable storage medium has further computer-readable instructions for:
storing the plurality of mass media parameters for each of the plurality of mass media items in the mass media item database.

19. The system of claim 18, wherein the non-transitory computer-readable storage medium has further computer-readable instructions for:
comparing the plurality of brand parameters for the at least one brand to the plurality of mass media item branding parameters for each of the plurality of mass media items in the mass media item database.

20. The system of claim 19, wherein the non-transitory computer-readable storage medium has further computer-readable instructions for:
returning a ranked list of mass media items that match the plurality of brand parameters for the at least one brand.
